(19) United States
(12) Patent Application Publication
(10) Pub. No.: US 2015/0248024 A1
(43) Pub. Date: Sep. 3, 2015

(54) Lighting Glasses

(71) Applicant: Pao-Liang Chen, Taichung City (TW)

(72) Inventor: Pao-Liang Chen, Taichung City (TW)

(21) Appl. No.: 14/194,884

(22) Filed: Mar. 3, 2014

(51) Int. Cl. G02C 11/04; F21V 33/00

(52) U.S. Cl. CPC G02C 11/04; F21V 33/0008; F21W 2131/30

(57) ABSTRACT

A pair of lighting glasses has a glasses body and a lighting module. The glasses body has a glasses frame, a waterproof cover, and two glasses temples. The waterproof cover is detachably mounted on the glasses frame. The glasses temples are transparent and are connected with the two ends of the glasses frame. The lighting module is mounted in the glasses body and has a main lamp, a cell, and two side lamps. The main lamp, the cell, and the side lamps are mounted in the glasses frame. The cell is electrically with a charging adapter aligned with the waterproof cover. Each side lamp is mounted along a longitudinal direction of a corresponding glasses temple.

### BACKGROUND OF THE INVENTION

1. Field of the Invention

The present invention relates to a pair of glasses, and more particularly to a pair of lighting glasses.

2. Description of Related Art

A conventional pair of lighting glasses has a glasses body and a lighting unit. The lighting unit is mounted on the glasses body and is exposed from the glasses body.

The pair of lighting glasses is applied for different occasions, such as in a specialized workplace or for providing an alerting effect to a bicycle rider. In the specialized workplace, for example, the pair of lighting glasses can emit light to lighten up a front of a user in a dark environment. For a bicycle rider, the pair of lighting glasses can emit light to the ambient environment for providing alerting effect to the bicycle rider.

However, the lighting unit is exposed from the glasses body, such that the lighting unit is vulnerable, and the pair of lighting glasses has an unattractive appearance.

### SUMMARY OF THE INVENTION

The main objective of the present invention is to provide a pair of lighting glasses to resolve the afore-mentioned problems.

The pair of lighting glasses has a glasses body and a lighting module.

The glasses body has a glasses frame, a cell opening cover, a waterproof cover, and two glasses temples.

The glasses frame has a main lamp recess and two side lamp recesses. The main lamp recess is formed in the glasses frame and has a main lamp opening and a cell opening. The main lamp opening and the cell opening both communicate with the main lamp recess. The side lamp recesses are formed in the glasses frame and are respectively adjacent to two ends of the glasses frame. The cell opening cover is mounted in and shelters the cell opening, and has a charging opening formed through the cell opening cover and communicating with the main lamp recess. The waterproof cover is detachably mounted in the charging opening. The glasses temples are transparent, are connected with the two ends of the glasses frame, and extend opposite to the main lamp opening.

The lighting module is mounted in the glasses body and has a main lamp, a control board, a switch, a cell, and two side lamps. The main lamp is mounted in the main lamp recess and faces the main lamp opening. The control board is mounted in the main lamp recess, is electrically connected with the main lamp, and has a charging adapter mounted on the control board and aligned with the charging opening. The switch is mounted in the glasses frame and is electrically connected with the control board. The cell is mounted in the main lamp recess, is electrically connected with the control board, and is adjacent to the cell opening. The side lamps are respectively mounted in the side lamp recesses, wherein each side lamp is mounted along a longitudinal direction of a corresponding glasses temple.

Other objectives, advantages and novel features of the present invention will become more apparent from the following detailed description when taken in conjunction with the accompanying drawings.

### BRIEF DESCRIPTION OF THE DRAWINGS

FIG. 1 is a perspective view of a preferred embodiment of a pair of lighting glasses in accordance with the present invention;

FIG. 2 is another perspective view of the pair of lighting glasses in FIG. 1;

FIG. 3 is an exploded perspective view of the pair of lighting glasses in FIG. 1;

FIG. 4 is a side view in partial section of the pair of lighting glasses along line 4-4 in FIG. 1;

FIG. 5 is another side view in partial section of the pair of lighting glasses along line 5-5 in FIG. 2; and

FIG. 6 is an operational perspective view of the pair of lighting glasses in FIG. 1.

### DETAILED DESCRIPTION OF PREFERRED EMBODIMENT

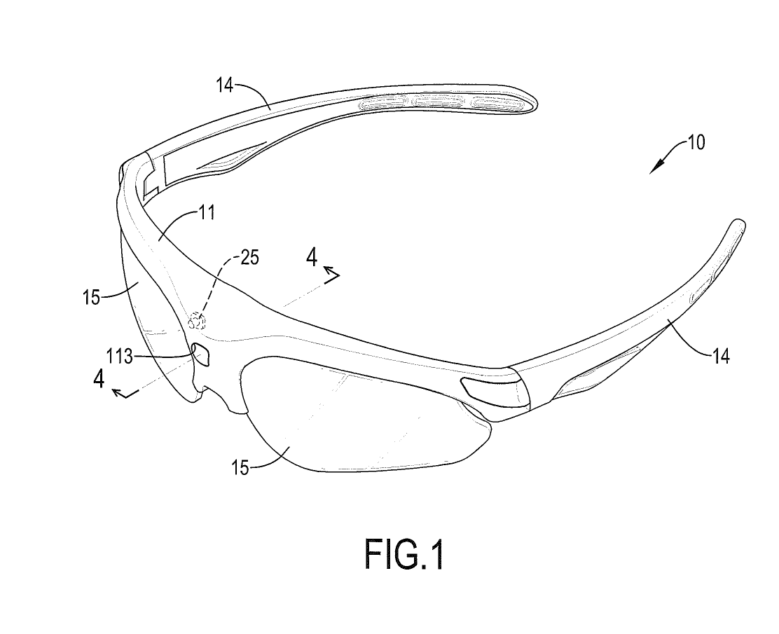

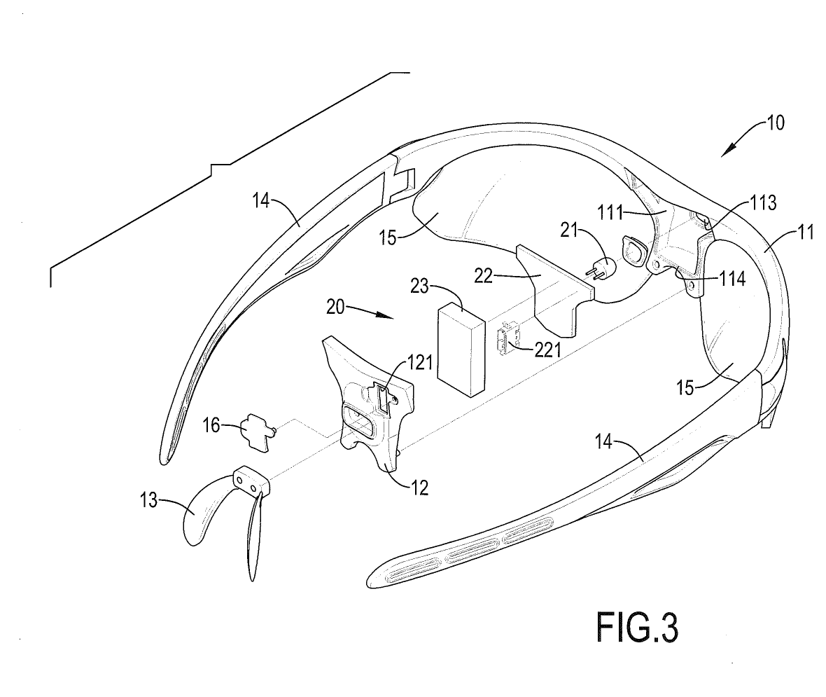

With reference to FIGS. 1 to 3, a preferred embodiment of a pair of lighting glasses in accordance with the present invention has a glasses body 10 and a lighting module 20.

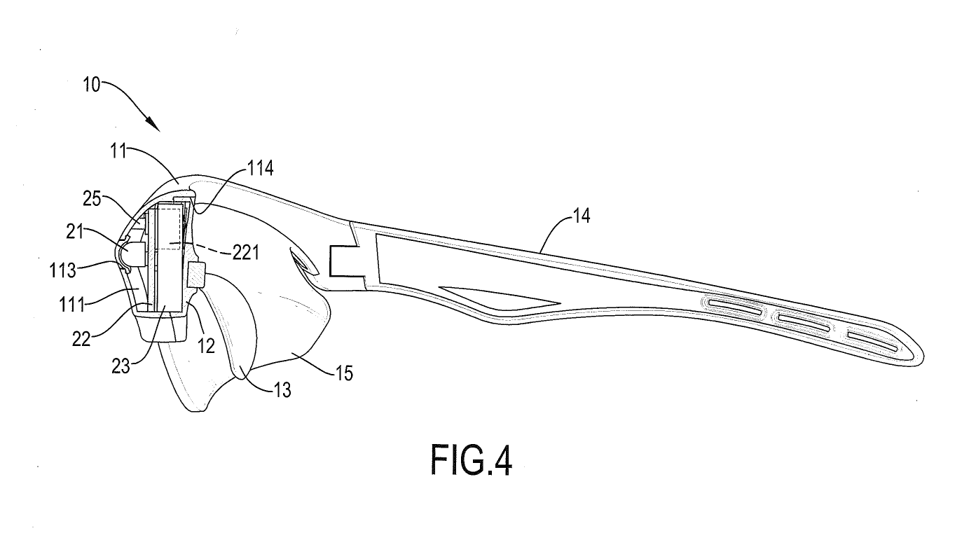

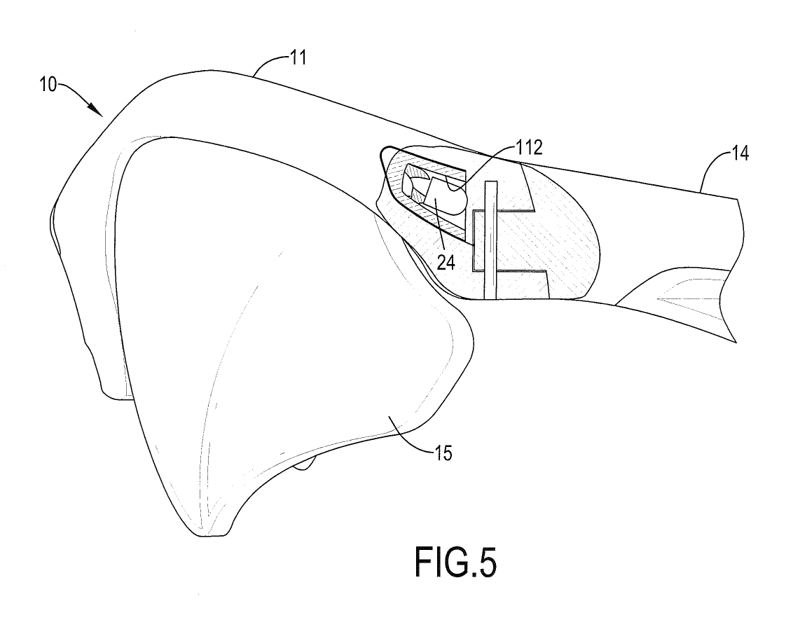

With reference to FIGS. 1, 3, 4 and 5, the glasses body 10 has a glasses frame 11, a cell opening cover 12, a waterproof cover 16, a nose pad 13, two glasses temples 14, and two lenses 15.

The glasses frame 11 has a main lamp recess 111 and two side lamp recesses 112. The main lamp recess 111 is formed in the glasses frame 11 and has a main lamp opening 113 and a cell opening 114. The main lamp opening 113 is formed in a front side of the glasses frame 11. The cell opening 114 is formed in a rear side of the glasses frame 11 and is located at a middle of the glasses frame 11. The side lamp recesses 112 are formed in the glasses frame 11 and are respectively adjacent to two ends of the glasses frame 11.

The cell opening cover 12 is mounted in and shelters the cell opening 114, and has a charging opening 121. The charging opening 121 is formed through the cell opening cover 12 and communicates with the main lamp recess 111. The waterproof cover 16 is made of rubber and is detachably mounted in and shelters the charging opening 121. The waterproof cover 16 can be opened to expose the charging opening 121.

The nose pad 13 is mounted on the cell opening cover 12 at a side opposite to the main lamp recess 111 and corresponds in position to the middle of the glasses frame 11. The glasses temples 14 are transparent and are respectively pivotally mounted on the two ends of the glasses frame 11. The glasses temples 14 extend opposite to the main lamp opening 113. The lenses 15 are mounted on the glasses frame 11 and are respectively located at two sides of the nose pad 13.

The lighting module 20 is mounted in the glasses body 10 and has a main lamp 21, a control board 22, a switch 25, a cell 23, and two side lamps 24.

The main lamp 21 is mounted in the main lamp recess 111 and faces the main lamp opening 113. The control board 22 is mounted in the main lamp recess 111, is electrically connected with the main lamp 21, and has a charging adapter 221. The charging adapter 221 is mounted on the control board 22 and is aligned with the charging opening 121. Preferably, the charging adapter 221 is a USB (Universal Serial Bus) charging adapter. The switch 25 is mounted in the glasses frame 11 and is electrically connected with the control board 22. Preferably, the switch 25 is a touch switch and is located at a middle of the front side of the glasses frame 11. Alternatively, the switch 25 may be exposed from the glasses frame 11, such that a user can flip the switch 25. The cell 23 is mounted in the main lamp recess 111, is electrically connected with the control board 22, and is adjacent to the cell opening 114. The side lamps 24 are respectively mounted in the side lamp recesses 112 and each side lamp 24 is mounted along a longitudinal direction of a corresponding glasses temple 14.

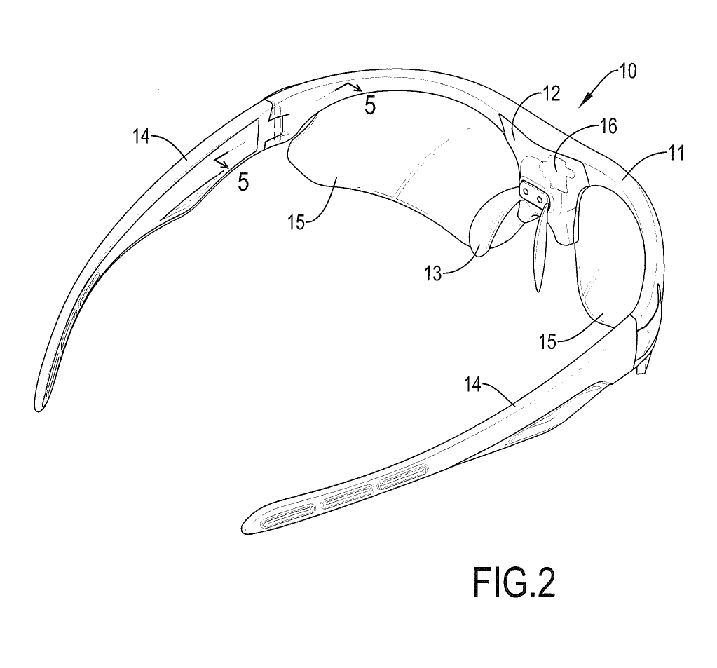

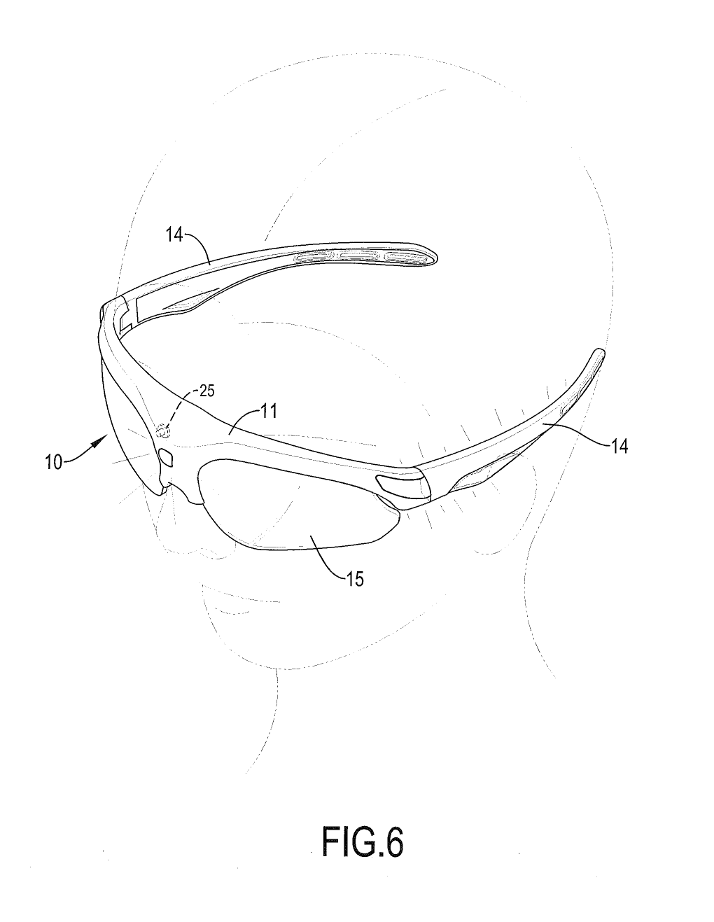

With reference to FIGS. 2, 3 and 6, in use, the pair of the lighting glasses is worn by a user. The user can touch the switch 25 to control the control board 22 to turn on the main lamp 21 and the side lamps 24 for emitting light. The control board 22 has multiple built-in lighting modes, such as a normal mode, a flicker mode, or an alternate mode to fit different using demands.

The lights emitted by the side lamps 24 can be respectively guided by the glasses temples 14 since each side lamp 24 is mounted along the longitudinal direction of the corresponding glasses temple 14. The light of the side lamps 24 can penetrate the transparent glasses temples 24 into an ambient environment. Therefore, the glasses temples 14 are illuminated to provide an alerting effect.

From the above description, it is noted that the present invention has the following advantages:
1. The lighting module 20 is mounted unexposed in the glasses body 10 to keep from collision and maintain aesthetic appearance for the pair of the lighting glasses.
2. The lights emitted from the side lamps 24 can be reflected from the glasses temples 14 to the ambient environment along the glasses temples 14 to provide an improved alerting effect.
3. The control board 22 has multiple lighting modes for different lighting effects.
4. When the cell 23 is short of electrical power, the waterproof cover 16 is detached from the charging opening 121. Then, the charging adapter 221 is electrically connected with an electrical power source to charge the cell 23. After the charging process is finished, the waterproof cover 16 is mounted in and shelters the charging opening 121 again. On the other hand, the waterproof cover 16 can prevent water from permeating into the lighting module 20.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pair of lighting glasses having:
a glasses body having
a glasses frame having
a main lamp recess formed in the glasses frame and having
a main lamp opening communicating with the main lamp recess; and
a cell opening communicating with the main lamp recess;
two side lamp recesses formed in the glasses frame and respectively adjacent to two ends of the glasses frame;
a cell opening cover mounted in and sheltering the cell opening, and having a charging opening formed through the cell opening cover and communicating with the main lamp recess;
a waterproof cover detachably mounted in the charging opening;
two glasses temples being transparent, connected with the two ends of the glasses frame, and extending opposite to the main lamp opening; and
a lighting module mounted in the glasses body and having
a main lamp mounted in the main lamp recess and facing the main lamp opening;
a control board mounted in the main lamp recess, the control board electrically connected with the main lamp and having a charging adapter mounted on the control board and aligned with the charging opening;
a switch mounted in the glasses frame and electrically connected with the control board;
a cell mounted in the main lamp recess, electrically connected with the control board, and being adjacent to the cell opening; and
two side lamps respectively mounted in the side lamp recesses, wherein each side lamp is mounted along a longitudinal direction of a corresponding one of the glasses temples.

2. The pair of lighting glasses as claimed in claim 1, wherein the charging adapter is a USB charging adapter.

3. The pair of lighting glasses as claimed in claim 1, wherein the switch is a touch switch.

4. The pair of lighting glasses as claimed in claim 2, wherein the switch is a touch switch.
